(19) United States
(12) Patent Application Publication
(10) Pub. No.: US 2006/0018123 A1
(43) Pub. Date: Jan. 26, 2006

(54) Curing light having a reflector

(76) Inventor: Eric P. Rose, Tarzana, CA (US)

Correspondence Address: DISCUS DENTAL IMPRESSIONS, INC., 8550 HIGUERA STREET, CULVER CITY, CA, 90232, US

(21) Appl. No.: 11/173,479

(22) Filed: Jun. 30, 2005

Related U.S. Application Data
(60) Provisional application No. 60/585,224, filed on Jul. 2, 2004.
(60) Provisional application No. 60/631,267, filed on Nov. 26, 2004.
(60) Provisional application No. 60/658,517, filed on Mar. 3, 2005.
(60) Provisional application No. 60/594,297, filed on Mar. 25, 2005.
(60) Provisional application No. 60/631,267, filed on Nov. 26, 2004.
(60) Provisional application No. 60/594,327, filed on Mar. 30, 2005.
(60) Provisional application No. 60/664,696, filed on Mar. 22, 2005.

(51) Int. Cl. F21V 7/00

(52) U.S. Cl. 362/341

(57) ABSTRACT

This invention relates to a curing light device suitable for curing light curable dental composite material. The device comprises a housing having a substantially hollow interior, a distal end, a proximal end, with the portion of which that is towards the distal end serving also as a handle. A light module is housed in a desirable position in the interior of the housing, and comprises at least one light source, at least one reflector to direct and/or focus the light from the light source, and at least one heat sink located in the proximity of the light source to divert heat away from the light source. The reflector and portions of the housing to which the reflector is attached have the same or substantially the same coefficient of thermal expansion.

### CROSS-REFERENCE TO RELATED APPLICATIONS

This application claims the benefit of U.S. provisional patent application Ser. No. 60/585,224, filed Jul. 2, 2004, entitled “Dental Light Devices With Phase Change Heat Sink”; 60/631,267, filed Nov. 26, 2004, entitled “Curing Light Having A Reflector”; 60/658,517, filed Mar. 3, 2005, entitled “Apparatus and Method For Radiation Spectrum Shifting in Dentistry Application”; 60/594,297, filed Mar. 25, 2005, entitled “Curing Light Having A Detachable Tip”; 60/631,267, filed Nov. 26, 2004, entitled “Curing Light Having A Reflector”; 60/594,327, filed on Mar. 30, 2005, entitled, “Curing Light”; and 60/664,696, filed Mar. 22, 2005, entitled “Curing Light Having A Detachable Tip”; the contents of all of which are hereby incorporated by reference.

The present application includes claims that may be related to the claims of co-pending United States patent applications, No. 10/______,______, to be concurrently filed, entitled “Illumination System for Dentistry Applications”; 10/______,______, to be concurrently filed, entitled “Voice Alert System for Dentistry Applications”; 10/______,______, to be concurrently filed, entitled “Light Guide for Dentistry Applications”; 10/______,______, to be concurrently filed, entitled “Retracting Devices”; and 10/______,______, to be concurrently filed, entitled “Support System for Dentistry”; the contents of all of which are hereby incorporated by reference.

### FIELD OF THE INVENTION

This invention relates to curing light devices for curing light activatable composite materials. Specifically, this invention relates to curing light devices having a reflector.

### BACKGROUND OF THE INVENTION

In the field of tooth restoration and repair, dental cavities are often filled and/or sealed with compounds that are photosensitive, either to visible and/or ultraviolet light. These compounds, commonly known as light-curable compounds, are placed within dental cavity preparations or onto dental surfaces and are cured when exposed to light from a dental curing light device.

Many light-curing devices are configured and constructed with reflectors for directing light from the light sources into the patient's mouths. The light sources maybe lamps, halogen bulbs or light-emitting diodes (LED).

The reflectors that are in use are ordinarily constructed mostly of metal. Typically, the part of the housing of the curing light attaching or holding the reflector is constructed out of a polymeric material.

### SUMMARY OF THE INVENTION

The present invention relates to a curing light device that resolves some of the problems of prior art devices, including thermal expansion problems during use. The curing light device is suitable for curing light curable dental composite material. The device includes a housing having a substantially hollow interior. The housing has a distal end and a proximal end. The portion of the housing that is disposed towards the distal end may serve as a handle. A light module is housed in a desirable position in the interior of the housing. The light module includes at least one light source, at least one reflector to direct and/or focus the light from the light source towards a target, and at least one heat sink located in the proximity of the light source to conduct heat away from the light source. The heat sink may include a phase change material, which may be more efficient in heat dissipation than a conventional metal block.

The proximal end of the housing includes a light emitting end. The proximal end of the housing may further include an extension portion, which may be a light guide, a light transport module, a lens cap, or the like, for transporting light to a desired position of a work surface, such as a patient's mouth.

In one embodiment, the reflector may be of a substantially cylindrical shape, having a hollow interior, a proximal end, a distal end, an inside and an outside surface. The reflector may be located inside the housing and may form an integral part of the proximal end of the housing, as the extension of the housing. The interior surface of the reflector may have a reflective surface. In one aspect, the reflective surface may include a thin coating of metal.

In another embodiment, the reflective surface is concave, and is adapted for directing and/or focusing light from a light source to a desired location, such as the mouth of a patient.

In yet another embodiment of the invention, the reflector and the portion of the housing in which it is mounted may be formed of the same material or different materials having similar coefficients of thermal expansion. This may potentially minimize stress to the assembled curing light device that would otherwise result from thermal effects during use.

In a further embodiment of the invention, the curing light may include a housing made of a polymer, and a polymeric, molded reflector having a reflective coating on its inside surface. In one aspect, the coating may be a metal coating, formed by any coating method including vacuum deposition.

In still another embodiment of the invention, the reflector and at least the portion of the housing close to the reflector are integrally molded together.

In yet another embodiment of the invention, the reflector may be attached to the housing. The attachment may be effected by an adhesive, and/or grooves or threads present in either one or both mating surfaces. The attachment may be permanent or temporary (i.e., removable and replaceable).

In yet a further embodiment of the invention, the housing includes an extension portion, which may include a light transport device or a light guide. In this embodiment, the reflector may be attached to the extension. The extension and the reflector may also be integrally molded together, or attached together. The attachment may be permanent or removable. In one aspect, the reflector may include a reflective coating.

In still yet another embodiment of the invention, the extension may include a lens cap. The reflector may be adapted to be connected to the lens cap and a portion of the proximal end of the housing. The lens cap, the reflector and the portion of the proximal end of the housing to which the reflector is attached may be made of the same material or material having substantially similar coefficient of thermal expansion.

The various reflective coatings described herewith may be very thin, but of sufficient thickness and/or substantial uniformity to form a good reflective surface. Any material that may form such a coating is suitable.

### BRIEF DESCRIPTION OF THE DRAWINGS

FIG. 1a shows a perspective view of the curing light of the invention;

FIG. 1b shows a side view of the curing light of the invention;

FIG. 1c shows a sectional side view of a curing light of the invention, depicting a reflector in an exemplary embodiment of the invention;

FIG. 2 shows a perspective posterior view of an embodiment of the reflector of the invention;

FIG. 3 shows a perspective anterior side view of the handle of the curing light of the invention;

FIG. 4 shows a perspective posterior view of an extension portion of a curing light of the invention.

FIG. 5 shows a cross sectional side-view of an embodiment of a charging base of the invention;

FIG. 6 shows a sectional view of an embodiment of the reflector of the invention;

FIG. 6a shows a perspective view of an embodiment of the reflector of the invention;

FIG. 7 shows a cross sectional side-view of an embodiment of the reflector with a light source of the invention;

FIG. 8 shows a cross sectional side-view of an embodiment of the reflector with a lens cap of the invention;

FIG. 9 shows an exploded perspective view of the handle portion of the housing of the curing light of the invention;

FIG. 10 shows an exploded perspective view of the proximal portion of the housing of the curing light of the invention;

### DETAILED DESCRIPTION OF THE INVENTION

The detailed description set forth below is intended as a description of the presently preferred device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

A curing light device useful for curing or activating light-activated materials is disclosed. The present invention has applications in a variety of fields, including but not limited to medicine and dentistry, where light-activated materials comprising a photoinitiator or photoinitiators are used. As an example, a photoinitiator absorbs light of a particular wavelength and initiates the polymerization of monomers into polymers.

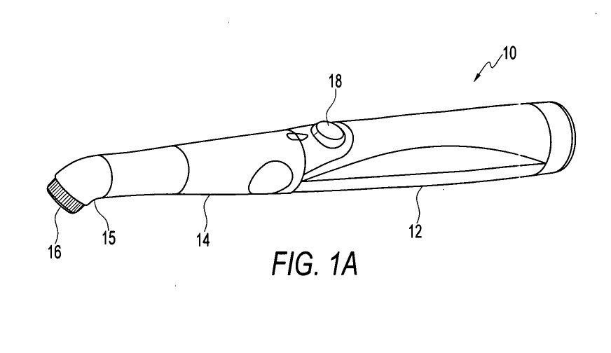

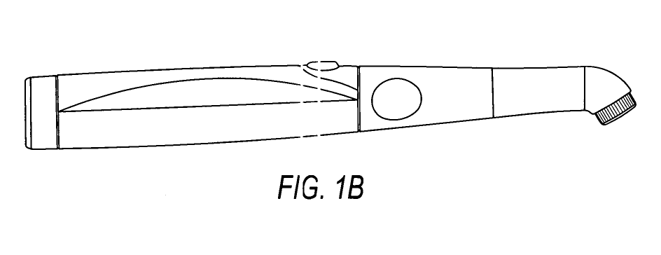

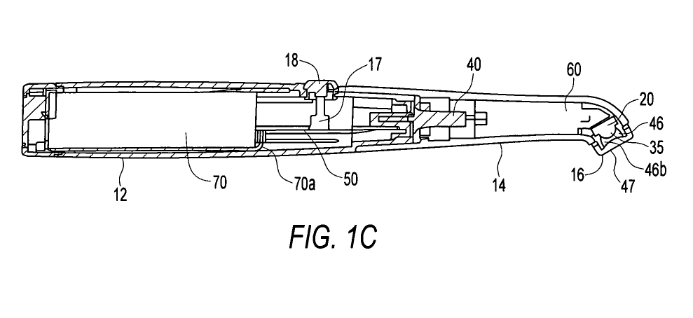

Exemplary embodiments, as depicted in FIGS. 1a, and 1b, show a perspective view and a side view, respectively, of a handheld curing light 10. The curing light 10 includes a longitudinal housing having a distal end and a proximal end with a substantially hollow interior. In the present example, the housing includes 2 portions, as depicted in the figures, the handle portion 12 towards the distal end and a front portion 14 towards the proximal end. It is noted, however, that a one-part housing may also be anticipated to be part of the present invention. The front portion 14 may also be an extension of the housing, especially if an integral housing is present.

Each of the portions 12 and 14 may also have a distal end and a proximal end. The portions 12 and 14 may be joined together by any attachment means, with the proximal end of handle portion 12 abutting the distal end of the front portion 14. Suitable attachment modes include, but are not limited to, friction fit, mating bayonet formations, tongue and groove type formations, internesting pin and pinhole formations, latches and other interconnecting structures. Adhesives, such as a structural adhesive including a cyanoacrylate based material such as, for example Loc-Tite™ or Super Glue™, other structural bonding adhesives including an epoxy, one or two part, polyurethane adhesives, one or two parts, or a foam mounting adhesive. The foam mounting adhesive may also aid in shock absorption. The adhesive may also be used, not just in place of the other attachment means, but in addition to other attachment means. In the illustrated embodiments, a friction fit mode is exemplified.

The housing, including its handle portion 12 and front portion 14, may be constructed out of a high temperature polymer or composite, such as ULTEM®, which is an amorphous thermoplastic polyetherimide or Xenoy® resin, which is a composite of polycarbonate and polybutyleneterephthalate or Lexan® plastic, which is a copolymer of polycarbonate and isophthalate terephthalate resorcinol resin, all available from GE Plastics, or any other suitable resin plastic or composite. At the same time, high impact polystyrene, some polyesters, polyethylene, polyvinyl chloride, and polypropylene may also be suitable.

Polymeric composites such as engineering prepregs or composites, are also suitable for the composition of the housing. The composites may be filled composites, filled with conductive particles such as metal particles or conductive polymers to aid in the heat dissipation of the device.

As shown in FIG. 1a, the extension portion or front portion of housing 14 of the curing light of the present invention also has a neck section 15, and this neck portion may be configured such that the emitting end 16 substantially coincides with the terminal end of the mounting deck, surface, platform or member of the light source 20, as shown in FIG. 1c.

An on/off button or switch 18 may be located on the handle portion 12, near the junction between the handle portion and the front portion 14, for manually turning on/off of the curing light. The button may be a molded part, made out of a polymer such as high temperature plastics or polymers used in other parts of the housing, as discussed above. It may also be of the same or different color from the housing. A different color may also help to accentuate its presence and make it easier to find.

In one embodiment, as shown, for example, in FIG. 1c, the front portion of the housing 14 may include a light module (not particularly delineated in the figures) in a desirable position in the interior of the front housing portion 14. The light module includes at least one light source 20, at least one reflector 46 having a reflective surface 46b to focus and/or direct the light coming from the light source 20, and at least one heat sink 60 located inside the light module to conduct heat away from the light source. The light module further includes a plastic lens 35 having a hemispherical dome to cover the light source 20 and also may serve to further focus the light generated.

In another embodiment, the curing light device may include at least one lens cap 47, as exemplified, to provide an exit aperture for light from light source 20 and to close the light emitting end 16 of the curing light.

Also included in the present embodiment are electrical and control components, which may be located within the housing portions 12, 14 towards the distal end of the curing light 10. The curing light 10 may be battery powered or tethered to a power source or transformer. Battery powered curing lights may afford better portability.

A battery 70 may provide electrical power for operating the light source 20 via battery contacts 70a and pin connector 40. In one embodiment, a single rechargeable battery such as a lithium ion battery may be used to power the curing light 10. The on/off button 18 may serve to manually operate the curing light by providing a user input signal through a shaft or post 17, which interfaces with a printed circuit board 50, may also be located within the handle portion 12, and is mounted close to the battery 70, for example. In one embodiment, printed circuit board 50 includes a device, which may or may not include a microprocessor, that monitors battery life, LED temperature, or system functionality.

The heat sink 60, exemplified here as an elongated heat sink, although other geometries are possible, is shown to be positioned inside the front portion 14, in close proximity to the light source, to conduct, or dissipate heat from the light source. If the light source is located in the handle portion 12 or an extension portion 14, then the heat sink is correspondingly located as well.

In another embodiment, the heat sink may be configured to have fins, corrugations, or other geometric features adapted to provide a larger surface area for convective cooling of the heat sink. In still another embodiment, the curing light device may include an electric motor mechanically coupled to a fan or turbine. The fan or turbine may be adapted to draw or urge ambient air across a surface of the heat sink to provide cooling of the heat sink.

The heat sink may be made of any suitable material that is efficient in heat conduction or dissipation, as mentioned above, and may include monolithic heat sinks and combinational heat sinks. Combinational Heat sinks are often a combination of two different kinds of materials, the first with a low thermal expansion rate and the second with high thermal conductivity. Monolithic heat sinks may be made of one material. Examples of some heat sink materials which may be used in curing light devices depicted herein include copper, aluminum, silver, magnesium, steel, silicon carbide, boron nitride, tungsten, molybdenum, cobalt, chrome, Si, SiO₂, SiC, AlSi, AlSiC, natural diamond, monocrystalline diamond, polycrystalline diamond, polycrystalline diamond compacts, diamond deposited through chemical vapor deposition and diamond deposited through physical vapor deposition, and composite materials or compounds. As mentioned, any materials with adequate heat conductance and/or dissipation properties may be used. If desired, a heat sink 120 may also have fins or other surface modifications or structures to increase surface area and enhance heat dissipation.

The heat sink 60 may include a phase change material, to more efficiently divert heat away from the light source or heat generating source. This is disclosed in a co-pending patent application, 10/______,______, entitled “Dental Light Devices Having an Improved Heat Sink”, to be filed concurrently; and a U.S. Provisional Patent Application No. 60/585,224, filed Jul. 2, 2004, entitled “Dental Light Devices with Phase Change Heat Sink”; incorporated herein by reference.

Heat sinks having a phase change material may more efficiently remove or divert heat from a light source or sources with a given weight of heat sink material when compared to a heat sink made of a solid block of thermally conductive material such as metal. Such a heat sink may even efficiently remove or divert heat from a curing light device when a reduced weight of the material is used. Using a phase change material enclosed inside a hollow thermally conductive material such as a metal heat sink instead of a conventional solid metal heat sink can decrease the weight of the curing light and increase the time the heat sink takes to reach the “shut off” temperature, as it is called in the dental curing light industry. The period prior to reaching the shut off temperature is called the “run time”. Increasing the “run time”, i.e., the time that the light can remain on, increases the time when a dentist can perform the curing or whitening procedure.

In one embodiment, a rechargeable dental curing light including at least one phase change material is disclosed. In another embodiment, a dental whitening light including at least one phase change material is disclosed. The heat sink includes a block of thermally conductive material, such as metal, having a bore or void space which is at least partially filled with a phase change material.

The heat sink may be constructed by hollowing out a thermally conductive material, such as metal, and at least partially filling the void with at least one phase change material prior to capping it to secure the phase change material inside, such that the at least one phase change material is substantially contained or surrounded by a thermally conductive material such as metal normally used in the construction of a conventional heat sink.

Alternatively, the heat sink may be cast or machined from a thermally conductive material, such as metal, to create walls surrounding a bore or void. The bore or void is partially filled with at least one phase change material prior to capping it to secure the material inside.

In one embodiment, the inventive heat sink may be used by itself. In another embodiment, it may be used in addition to a fan, in conjunction with a conventional metal block heat sink or combinations thereof.

The inventive heat sink may be installed into the dental curing light, imaging or whitening light source in the same manner a conventional metal block heat sink is installed, such as by attaching it to the heat generating source, i.e., the light source, which may include any of the ones mentioned above or combinations thereof, or by attaching it to another heat sink.

Suitable phase change material may include organic materials, inorganic materials and combinations thereof. These materials can undergo substantially reversible phase changes, and can typically go through a large, if not an infinite number of cycles without losing their effectiveness. Organic phase change materials include paraffin waxes, 2,2-dimethyl-n-docosane (C₂₄H₅₀), trimyristin, ((C₁₃H₂₇COO)₃C₃H₃), and 1,3-methyl pentacosane (C₂₆H₅₄). Inorganic materials such as hydrated salts including sodium hydrogen phosphate dodecahydrate (Na₂HPO₄.12H₂O), sodium sulfate decahydrate (Na₂SO₄.10H₂O), ferric chloride hexahydrate (FeCl₃.6H₂O), and TH29 (a hydrated salt having a melting temperature of 29° C., available from TEAP Energy of Wangara, Australia) or metallic alloys, such as Ostalloy 117 or UM47 (available from Umicore Electro-Optic Materials) are also contemplated. Exemplary materials are solids at ambient temperature, having melting points between about 30° C. and about 50° C., more for example, between about 35° C. and about 45° C. Also, the exemplary materials have a high specific heat, for example, at least about 1.7, more for example, at least about 1.9, when they are in the state at ambient temperature. In addition, the phase change materials may, for example, have a specific heat of at least about 1.5, more for example, at least about 1.6, when they are in the state at the elevated temperatures.

The phase change material may also have a high latent heat of fusion for storing significant amounts of heat energy. This latent heat of fusion may be, for example, at least about 30 kJ/kg, more for example, at least about 200 kJ/kg.

Thermal conductivity of the materials is a factor in determining the rate of heat transfer from the thermally conductive casing to the phase change material and vice versa. The thermal conductivity of the phase change material may be, for example, at least about 0.5 W/m° C. in the state at ambient temperature and at least about 0.45 W/m° C. in the state at elevated temperature.

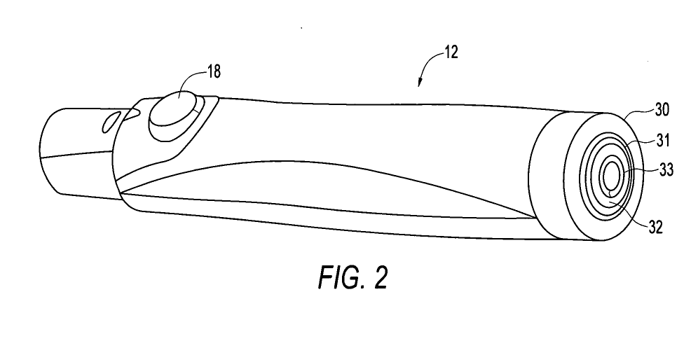

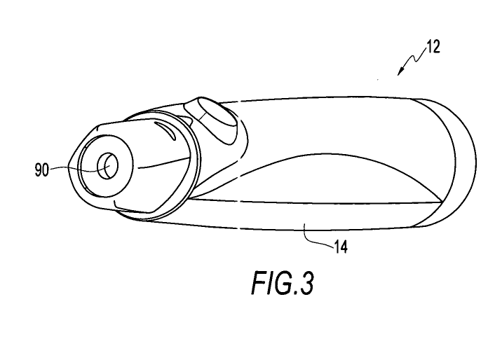

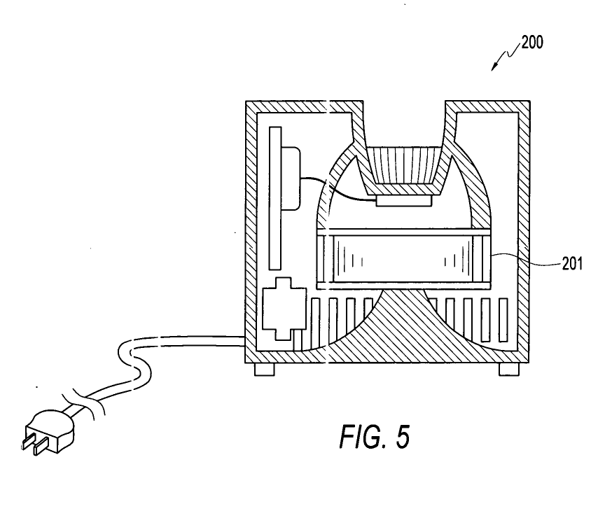

A perspective posterior view and an anterior view of an embodiment of the handle portion 12 are shown in FIGS. 2 and 3, respectively. At the distal end of the handle may be an end cap 30, including, according to one embodiment, electrical contacts 31, 32, 33 so that the curing light may be seated in a charger base (shown in FIG. 5) for recharging the battery 70, if the curing light is battery powered. The end cap 30 and/or the charger base (as exemplified in FIG. 5), may also be so constructed as to provide means for diverting heat away from the curing light after use.

The end cap 30 is cylindrical in shape and may be attached to the distal end of the handle portion 12. It may be molded as part of the handle portion 12. It may also be attached by other means, such as adhesive bonding, heat bonding, or threaded attachment.

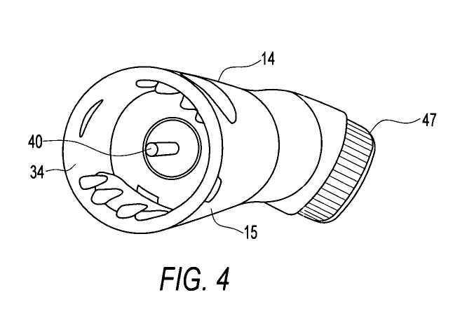

In one embodiment, the proximal end of the handle portion 12 may be slightly tapered, as shown in FIGS. 2, 3. The inside diameter of the distal end of the front portion 14 may be slightly enlarged, as shown, such that the tapered end of the handle portion 12 fits into a receptacle region 34 of the front portion 14 (as shown in FIG. 4), for example, with a friction fit.

In one embodiment, the handle portion 12 and the extension tube portion 14 are mechanically and electrically connected via a pin connector 40, and receptacle 90 as shown in FIGS. 4, 3 respectively. As mentioned above, other connector means may also be used.

In one embodiment of the invention, as shown in FIG. 5, the charger base may include an electric motor mechanically coupled to a fan or turbine. The fan or turbine may be adapted to draw or urge ambient air across a surface of the heat sink 60 to provide cooling of the heat sink 60. In one embodiment, this cooling may occur when the curing light is at rest or being recharged. In another embodiment, the cooling means is present inside a charger base or cradle 200, for recharging the curing light. In other embodiments, the charger base or cradle 200 may not have a fan 201 or cooling means, but instead or additionally, many include a display panel (not shown) for displaying a condition of the battery.

Referring again to FIG. 1a, neck portion 15 is present towards the distal end of the front housing portion or extension portion 14, ending in a light-emitting end 16. A light source 20, shown (in FIG. 1c) as an LED, may be housed near the neck portion 15, and for example, close to the distal end of the extension portion 14, in section 16. In an exemplary embodiment, the reflector 46 may be mounted inside section 16 as shown in FIG. 1c, to reflect light generated by the light source 20 to a desired location on the work surface, such as a patient's mouth.

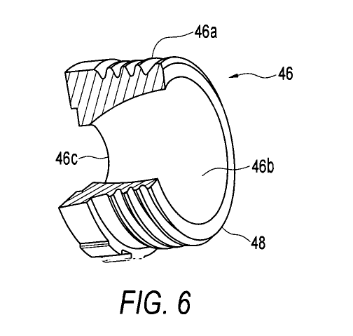

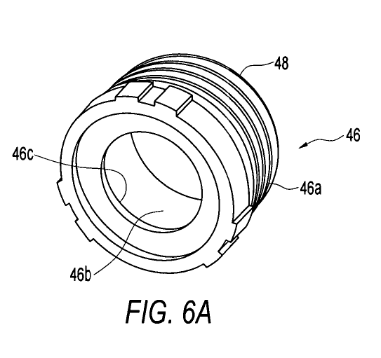

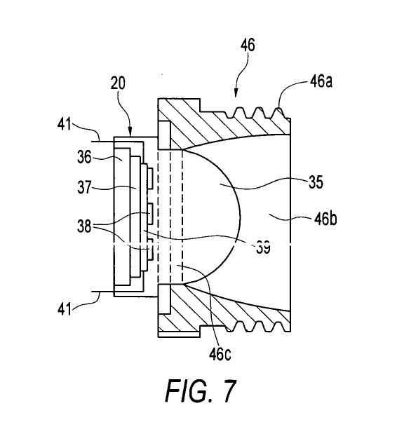

The reflector 46 may be of a cylindrical shape, as exemplified in FIGS. 6, 6a, 7. In one embodiment, the reflector 46 may be used to retain the light source 20 within the emitting end 16 of the neck section 15 (as shown in FIG. 1c).

In the present embodiment shown in FIGS. 6, 6a, the reflector 46 includes a threaded portion 46a, a reflective surface 46b and an LED aperture 46c, and may be mounted to the curing light 10 (as shown in FIG. 1a) by inserting into the neck section 15. The attachment may be facilitated by fixing formations, for example, threads, grooves, channels, depressions, protrusions or similar, on both the neck section 15 and the reflector 46 (not shown), for example, if protrusions are present on either the reflector 46 or the neck section 15 and corresponding grooves may be present on either to receive them. The reflector may also fit into the curing light by means of a friction fit or the reflector may be retained with an adhesive, such as structural bonding adhesive including an epoxy, one or two part, polyurethane adhesives, one or two parts, a cyanoacrylate based adhesive, or a foam mounting adhesive. The foam mounting adhesive may also aid in shock absorption.

The reflector 46 may also be molded onto the end of section 15 and housed inside section 16, in addition to being threaded or otherwise fitted to neck section 15, as discussed above.

In one embodiment, the reflector 46 may be permanently attached to either the proximal end of the front portion 14 or an extension thereof. In another embodiment, the reflector 46 may be made to be removable. If an extension portion 16 is present, the extension may include a permanently attached or integrally molded reflector, and may be made to be removable from the proximal end of the housing as one part.

In an exemplary embodiment, the reflector 46 may be metallized on its interior surface 46b so as to create a reflective surface. Depending on the thickness of the metal coating, the amount of reflection can be varied. For example, a high degree of reflectivity is desirable.

The reflective surface may also shape and focus the light emitted by the light source 20. In some embodiments, a focusing lens may also be used. The direction of light reflection depends on the shape or curvature of the reflective surface 46b. For example, a concave surface may be used, or a certain degree of curvature of the surface may be designed to influence the direction of the reflected light, individually or collectively. Thus, the shape and the curvature of the reflective surface will help to shape and focus the light to any desired direction.

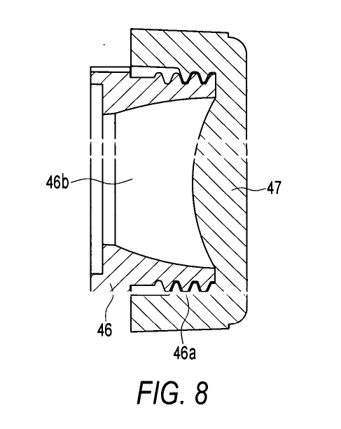

The threaded portion 46a of the reflector 46 may be towards the end distal 48, surrounding the LED aperture 46c, as is shown in FIG. 6a. The threaded section 46a may be adapted to receive a lens cap 47 which may include corresponding grooves for threading onto the reflector 46, as exemplified in FIG. 8. The lens cap 47 may serve to seal the light emitting end 16 of the curing light 10 and may also serve to focus the light from light source 20 (see FIG. 1c).

The reflector 46 may be, for example, molded or cast out of a polymer, such as those used for the construction of the housing 101. In another embodiment, the reflector 46 may be, for example, injection molded using a mold. This may produce higher degree of reproducibility of the reflectors 46. The polymers, as noted, may also be those that can be molded or cast and coated.

In one embodiment, the reflective surface is, for example, metallic, and may be formed through coating. Any one or more coating techniques for forming a thin film coating may be used. Such techniques include any methods of metallization of a polymeric surface such as Gas-phase coating techniques. These techniques are generally known as physical vapor deposition (PVD), chemical vapor deposition (CVD), and plasma deposition. These techniques commonly involve generating a gas-phase coating material that condenses onto or reacts with a substrate surface. Various gas-phase deposition methods are described in “Thin Films: Film Formation Techniques,” Encyclopedia of Chemical Technology, 4.sup.th ed., vol. 23 (New York, 1997), pp. 1040-76, incorporated herein by reference.

PVD is a vacuum process where the coating material is vaporized by evaporation, by sublimation, or by bombardment with energetic ions from a plasma (sputtering). The vaporized material condenses to form a solid film on the substrate. The deposited material is generally metallic or ceramic in nature (see Encyclopedia of Chemical Technology as cited above).

CVD processes involve reacting two or more gas-phase species (precursors) to form solid metallic and/or ceramic coatings on a surface (see Encyclopedia of Chemical Technology as cited above). In a high-temperature CVD method, the reactions occur on surfaces that can be heated at 300° C. to 1000° C. or more, and thus the substrates are limited to materials that can withstand relatively high temperatures. At the same time, in a plasma-enhanced CVD method, the reactions are activated by a plasma, and therefore the substrate temperature can be significantly lower, and polymers such as polystyrene and polyester may also be used in the construction of the reflector.

Plasma deposition, also known as plasma polymerization, is analogous to plasma-enhanced CVD, except that the precursor materials and the deposited coatings are typically organic in nature. The plasma significantly breaks up the precursor molecules into a distribution of molecular fragments and atoms that randomly recombine on a surface to generate a solid coating (see Encyclopedia of Chemical Technology as cited above). A characteristic of a plasma-deposited coating is the presence of a wide range of functional groups, including many types of functional groups not contained in the precursor molecules, thus it is less amenable to use in the present invention.

Other embodiments of the invention may include a reflecting surface that includes anodized aluminum, and a reflecting surface formed by vapor deposition of dielectric layers onto metallic layers. For example, a metallic layer may be deposited on an anodized surface as a base reflection layer, followed by deposition of a low refractive index and then a high refractive index dielectric layer. Such materials include those available from Alannod, Ltd. of the United Kingdom, and may include a cholesteric liquid crystal polymer.

Cholesteric liquid crystal polymers can reflect rather than transmit light energy, and may be used either as a surface coating layer or as the main ingredient of the reflector, as described, for example, in U.S. Pat. Nos. 4,293,435, 5,332,522, 6,043,861, 6,046,791, 6,573,963, and 6,836,314, the contents of which are incorporated herein by reference. Other materials with similar properties may also be employed in the invention.

The coating methods used in the invention may include, for example, those that may be operated at lower temperatures to create a thin and substantially continuous layer on a polymeric surface. Such methods may add to the versatility and flexibility in the choice of materials, both the polymeric material and the metallic coating. Some metallic coating may be reflective only as a thin coating. These may thus be used, as well as lower temperature polymers.

Any metal that is amenable to being coated as a relatively thin film to generate a reflective surface may be used. Some examples include aluminum, indium/tin oxide, silver, gold and mixtures thereof. Aluminum may also be in the form of anodized aluminum.

In one embodiment, reflector 46 and an extension or front portion 14, or at least portions of the front portion 14 may be, for example, made out of the same material, similar material, or material having little or no difference in the coefficients of thermal expansion. Where different coefficients of thermal expansion are present, as is found in a reflector 46 made of metal and a plastic extension, the result may be hoop stress imparted from the metal reflector into the housing as the reflector expands at a rate greater than the extension. Such hoop stress may lead to premature failure of the unit. Such failure is minimized or eliminated by the present embodiment of the invention.

For example, a polymer that may be molded or cast; or a metal or metallic alloy may be used, as mentioned above, if the front portion of the curing light is also made of metal. Suitable polymers include polyethylene, polypropylene, polybutylene, polystyrene, polyester, acrylic polymers, polyvinylchloride, polyamide, or polyetherimide like ULTEM®; a polymeric alloy such as Xenoy® resin, which is a composite of polycarbonate and polybutyleneterephthalate or Lexan® plastic, which is a copolymer of polycarbonate and isophthalate terephthalate resorcinol resin (all available from GE Plastics), liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference)or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used. For example, a blend of polycarbonate and ABS (Acrylonitrile Butadiene Styrene) may be used for the housing 101a.

Generally, materials usable in housing 101 include, for example, polymeric materials or composites having high temperature resistance.

A liquid crystal polymer or a cholesteric liquid crystal polymer, such as one that can reflect rather than transmit light energy, may be used in various embodiments of the invention. For example, a liquid crystal polymer or a cholesteric liquid crystal polymer may be used as a coating on an interior surface 101 of the light module housing 101, to minimize the waste of light energy generated by the light source (as described, for example, in U.S. Pat. Nos. 4,293,435, 5,332,522, 6,043,861, 6,046,791, 6,573,963, and 6,836,314, the contents of which are incorporated herein by reference).

In general, a plastic housing is used for a curing light device. Thus, a plastic reflector is chosen. In addition, a plastic molded reflector 46 also offers increased impact resistance in various embodiments of the invention. When the plastic reflector 46 is molded out of the same material as the extension housing, the two components, when mated as system, form a much more impact resistant configuration than a metal reflector bonded into the plastic extension during drop test. Without wishing to be bound to a theory, it is surmised that during drop tests with the system having a metal reflector, more of the load is directly transmitted to the extension, increasing the potential for high stress levels in the extension and failure of the extension. Additionally, metal reflectors are usually bonded to the housing using a bonding adhesive. Because the metal reflector does not absorb impact, it may simply separate from the extension when the curing light is dropped, breaking its adhesive bond.

As mentioned above, the reflector, 46, may be, for example, molded, as the molding process is highly repeatable. A mold may be made and the optical geometry of the inside of the reflector remains substantially invariant over the molding process, from part to part. This compares very favorably with the manufacturing process involved in making metal reflectors. In particular, individually machining metal reflectors may create a potential for high variability in the geometry and the surface reflectivity. This variability may be evident not just from reflector to reflector, but over the surface of a single reflector. This variability may lead to lower illumination efficiencies.

The plastic reflector also allows for a vacuum metallization process to be used to create a mirror like finish, thus yielding a high, to very high, level of efficiency in the illumination system. This is especially true in comparison to a polished surface of a machined metal part, since polishing is more likely to create pits and non-uniformity in the metal surface depending on the abrasive polishing materials and methods used.

Since the molding process is amenable to mass production, the use of a plastic molded part that is metallized also may yield a more efficient illumination system for a given price in comparison to a machined metal part.

In addition, plastic reflectors may have an extra advantage of being adapted to be formed in any color. Experimentation has found that molding the reflector out of a white plastic may yield better reflectivity.

In one embodiment, the thickness of the reflective layer may be sufficiently thin so as not to substantially affect the thermal expansion of the base polymer, or the mechanical properties of the reflector.

FIG. 7 further shows how the reflector 46 may be disposed upon the light source 20. The light source may be any suitable light source including, but not limited to, a single LED device, a single LED device array, a plurality of LED arrays, a single diode laser device, an array of diode laser devices, a Vertical Cavity Surface Emitting Laser (VCSEL) device or array of devices, or one or more LED or laser modules. The wavelength of light emitted from the light source may be of any desired wavelength or combination of different wavelengths, chosen according to the characteristics of the photoinitiator(s) in the light-activated material to be cured. Any of the semiconductor and heat sink arrangements described herein may be used to construct desired dental curing light devices.

In an exemplary embodiment, a single LumiLeds™-type LED light source 20 may be mounted in the front portion 14 at its light-emitting end 16. The light source may be a Luxeon™ V Star light source which may include up to four LEDs mounted on a single sub-mount and encapsulated by a single lens. Such a light source is disclosed in U.S. Pat. No. 6,498,355 to Harrah et al and U.S. Pat. No. 6,274,924 to Carey et al, which are both assigned to LumiLeds Lighting of San Jose, Calif., the entire disclosure of which is incorporated herein by reference. The Luxeon™ V Star light source is available in a blue color, Lambertian radiation pattern, and produces about 525 mW/cm². Other wavelengths are also possible.

As shown in FIG. 7, the light source 20 may include any or all of the following: a slug 36, a sub-mount 37, up to four LEDs 38 mounted thereto, a lead frame 39, and a metal lead 41 extending through the lead frame. A plastic lens 35 having a hemispherical dome shape covers the four LEDs.

In one embodiment, the curing light further includes an extension portion such as light transport, a light pipe, a light guide, or similar structure, for directing or transporting light to a desired location of a work surface such as patient's mouth. The light module may also be located in the extension portion, but is generally located in the housing.

An elongated mounting member (not shown), which may be made of copper or a brass material, may be used for mounting the light source 20 (as shown in FIG. 7) thereon. The mounting member may include an elongated base section and a mounting section with a mounting deck. The light source 20 may be mounted on the mounting section and the mounting member may be configured to reside within the extension tube 14.

As noted, the extension may be a light guide or any of the structures mentioned above, for directing the light onto a working surface. In one embodiment, the light source and the reflector maybe located away from the emitting end 16 so that the locus of heat dissipation from the curing light is comparatively remote from patient.

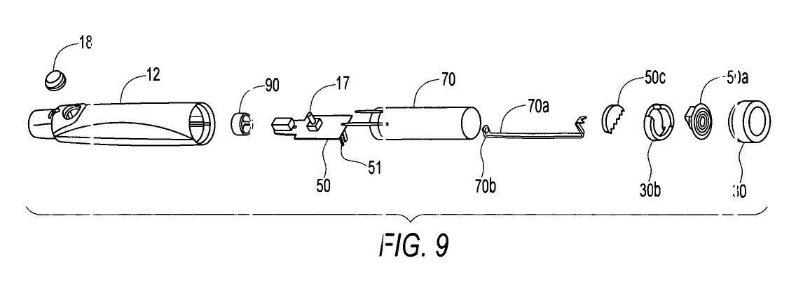

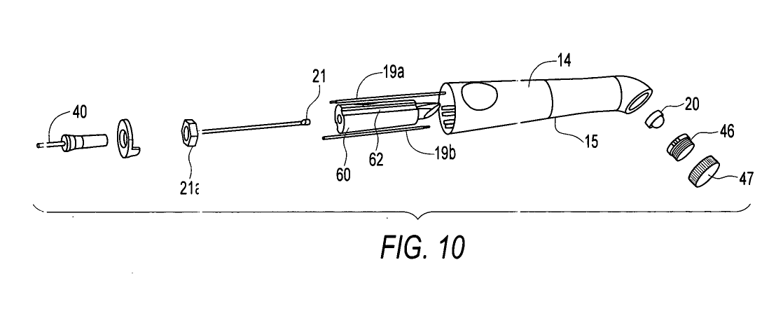

FIGS. 9, 10 show exploded views of the housing portions 12, 14 respectively. In FIG. 9, the printed circuit board or microprocessor (PCB) 50 is coupled to an end cap 50a and pins 51 that may be plugged into a plug receptacle 70b at the end of a cable assembly 70a. The other end of the cable assembly, the end cap 50 and end cap 30 may be assembled together by means of a ring retainer 30b. A foam insert 50c may be used, for example, to buffer the plug receptacle 70b and the end cap 30. Any elastomer may be used in the construction of the foam insert including various copolymers or block copolymers(Kratons®) available from Kraton Polymers such as styrene-butadiene rubber or styrene isoprene rubber, EPDM (ethylene propylene diene monomer) rubber, nitrile (acrylonitrile butadiene) rubber, latex rubber and the like. Foam materials may be closed cell foams or open cell foams, and may include, but is not limited to, a polyolefin foam such as a polyethylene foam, a polypropylene foam, and a polybutylene foam; a polystyrene foam; a polyurethane foam; any elastomeric foam made from any elastomeric or rubber material mentioned above; or any biodegradable or biocompostable polyesters such as a polylactic acid resin (comprising L-lactic acid and D-lactic acid) and polyglycolic acid (PGA); polyhydroxyvalerate/hydroxybutyrate resin (PHBV) (copolymer of 3-hydroxy butyric acid and 3-hydroxy pentanoic acid (3-hydroxy valeric acid) and polyhydroxyalkanoate (PHA) copolymers; and polyester/urethane resin.

In an exemplified embodiment, the PCB assembly 50 may be configured to provide time cycles of one to two minutes or so on duration, to thereby cure light activated compositions. At the end of each such cycle, the curing light may be turned back on manually. The PCB may also be configured to have a high temperature shut off that can automatically shut the curing light down during any of the selected cycles.

In FIG. 10, the pin connector 40 may interface with power relays 19a, 19b, to conduct electrical current to and from the light source 20 and may fit into the external grooves 62 of the heat sink 60 to pass to the neck portion 15, and with a thermistor 21, which is located in proximity to the heat sink 60 and is attached to it by means of, for example, a nut 21a. The thermistor 21 may also be used to monitor the temperature of the heat sink 60 and relay this information, for example, via pin connector 40 to the PCB assembly 50. This communication may provide the PCB assembly 50 with a signal to shut off the curing light once the heat sink has reached its “shut off” temperature.

Having described the invention in the preferred embodiments, the invention is further embodied in the appending claims set forth below.

1. A curing light suitable for curing light curable dental composite materials comprising:
a substantially cylindrical housing having a substantially hollow interior, a distal end, and a proximal end, with the portion towards the distal end serving as a handle;
a light module housed inside the housing towards its proximal end, comprising at least one light source, at least one reflector to direct and/or focus the light from the light source, and at least one heat sink located in the proximity of the light source to divert heat away from the light source;
wherein said reflector comprises a material having a substantially similar coefficient of thermal expansion as the material of the distal end of the housing.

2. The curing light of claim 1 wherein said reflector comprises a substantially cylindrical shape having a hollow interior, a proximal end, a distal end, an inside and an outside surface, located inside the housing and forming an integral part of the proximal end of the housing.

3. The curing light of claim 2 wherein said proximal end of the housing and said reflector are integrally molded.

4. The curing light of claim 1 wherein said housing comprises of two separate portions joined together by a friction fit.

5. The curing light of claim 1 wherein said proximal end of the housing further comprise an extension portion which can be a light guide or a light transport module, for transporting light to a desired position of the a work surface, such as a patient's mouth.

6. The curing light of claim 1 wherein said inside surface of the reflector comprises a reflective surface.

7. The curing light of claim 6 wherein said reflective surface comprises a thin coating of metal.

8. The curing light of claim 6 wherein said reflective surface is concave for directing and/or focusing the light form the light source to a desired location, such as the mouth of a patient.

9. The curing light of claim 1 wherein at least a portion of the housing comprising the reflector comprises of the same material as the reflector.

10. The curing light claim 1 comprises a housing comprising a polymer, and a polymeric molded reflector having a reflective coating on its inside surface.

11. The curing light of claim 6 wherein said reflective surface comprises a metal coating, formed by vacuum deposition.

12. The curing light of claim 6 wherein said reflective coating is of a thickness so as not to affect the expansion properties of the material comprising the reflector.

13. The curing light of claim 1 wherein said reflector is attached to the housing with an attachment means selected from the group consisting of an adhesive bond, a mating of grooves or threads present in either one or both mating surfaces of the housing and the reflector.

14. The curing light of claim 13 wherein said attachment is removably.

15. The Curing light of claim 5 wherein said reflector is attached to the extension portion.

16. The curing light of claim 5 wherein said reflector is integrally molded to the extension portion.

17. The curing light of claim 16 wherein said reflector and light transport forms a removable part of the housing.

18. The curing light of claim 6 wherein said reflective coating is of sufficient thickness and/or substantial uniformity to form an efficient reflective surface.

19. The curing light of claim 6 wherein said reflective coating is formed of a material selected from the group consisting of aluminum, anodized aluminum, indium/tin oxide, silver, gold and mixtures thereof.

20. The curing light of claim 1 wherein said material is selected from the group consisting of an amorphous thermoplastic polyetherimide; a composite of polycarbonate and polybutyleneterephthalate; a copolymer of polycarbonate and isophthalate terephthalate resorcinol resin; high impact polystyrene; polyesters; polyethylene; polyvinyl chloride; polypropylene and mixtures and composites thereof.

21. The curing light of claim 20 wherein said polymeric composites is selected from the group consisting of engineering prepregs, conductive composites, and mixtures thereof.

22. The curing light of claim 1 wherein said light source is selected from a group consisting of a single LED chip, single LED chip array, an array of LED chips, a single diode laser chip, an array of diode laser chips, a VCSEL chip or array, and combinations thereof.

23. The curing light of claim 1 wherein said light source emits light of multiple wavelengths.

24. The curing light of claim 1 wherein said heat sink comprises of any suitable material selected from the group consisting of copper, aluminum, silver, magnesium, steel, silicon carbide, boron nitride, tungsten, molybdenum, cobalt, chrome, Si, SiO.sub.2, SiC, AlSi, AlSiC, natural diamond, monocrystalline diamond, polycrystalline diamond, polycrystalline diamond compacts, amorphous diamond and combinations thereof.

25. The curing light of claim 1 wherein said heat sink is of the type selected from the group consisting of a thermoelectric type heat sinks, a heat sinks employing a phase change materials and combinations thereof.

26. The curing light of claim 1 wherein said reflector is attached to the housing using an adhesive selected from the group consisting of a one or two part epoxy, one or two part polyurethane adhesives, a foam mounting adhesive and combinations thereof.

27. A portable curing light suitable for curing light curable dental composite materials comprising:
a housing having a substantially hollow interior, a distal end, a proximal end, and a portion towards the distal end serving as a handle;
a battery mounted inside said handle for powering said curing light;
at least one light source mounted on an elongated heat sink extending a length of the interior portion of the housing towards its proximal end;
a reflector comprising a substantially cylindrical body, forming part of the proximal end of the housing;
wherein said reflector comprises a material having a substantially similar coefficient of thermal expansion as the material of the distal end of the housing.

28. The curing light of claim 27 wherein said proximal end of the housing and said reflector are integrally molded.

29. The curing light of claim 27 wherein said proximal end of the housing further comprise an extension portion which can be a light guide or a light transport module, for transporting light to a desired position of the a work surface, such as a patient's mouth.

30. The curing light of claim 27 wherein said inside surface of the reflector comprises a reflective surface.

31. The curing light of claim 30 wherein said reflective surface comprises a thin coating of metal.

32. The curing light of claim 30 wherein said reflective surface is concave for directing and/or focusing the light form the light source to a desired location, such as the mouth of a patient.

33. The curing light claim 27 comprises a housing comprising a polymer, and a polymeric molded reflector having a reflective coating on its inside surface.

34. The curing light of claim 30 wherein said reflective surface comprises a metal coating, formed by vacuum deposition.

35. The curing light of claim 27 wherein said reflector and at least the portion of the housing close to the reflector comprise the same material.

36. The curing light of claim 30 wherein said reflective coating is of a thickness so as not to affect the expansion properties of the material comprising the reflector.

37. The curing light of claim 27 wherein said reflector is attached to the housing wit an attachment means selected from the group consisting of an adhesive bond, a mating of grooves or threads present in either one or both mating surfaces of the housing and the reflector.

38. The curing light of claim 37 wherein said attachment is removably.

39. The Curing light of claim 29 wherein said reflector is attached to the extension portion.

40. The curing light of claim 29 wherein said reflector is integrally molded to the extension portion.

41. The curing light of claim 40 wherein said reflector and light transport forms a removable part of the housing.

42. The curing light of claim 30 wherein said reflective coating is of sufficient thickness and/or substantial uniformity to form an efficient reflective surface.

43. The curing light of claim 30 wherein said reflective coating is formed of a material selected from the group consisting of aluminum, anodized aluminum, indium/tin oxide, silver, gold and mixtures thereof.

44. The curing light of claim 27 wherein said material is selected from the group consisting of an amorphous thermoplastic polyetherimide; a composite of polycarbonate and polybutyleneterephthalate; a copolymer of polycarbonate and isophthalate terephthalate resorcinol resin; high impact polystyrene; polyesters; polyethylene; polyvinyl chloride; polypropylene and mixtures and composites thereof.

45. The curing light of claim 44 wherein said polymeric composites is selected from the group consisting of engineering prepregs, conductive composites, and mixtures thereof.

46. A portable curing light suitable for curing light curable dental composite materials comprising:
a housing having a substantially hollow interior, a distal end, a proximal end, and a portion towards the distal end serving as a handle;
a battery mounted inside said handle for powering said curing light;
at least one light source mounted on a heat sink located towards the proximal end of the housing;
a molded reflector comprising a substantially cylindrical body, forming part of the proximal end of the housing;
wherein said reflector and at least a portion of the housing towards the proximal end comprises the same polymeric material.

47. The curing light of claim 46 wherein said reflector and at least a portion of the housing towards the proximal end are integrally molded together.

48. The curing light of claim 46 wherein said inside surface of the reflector comprises a reflective surface.

49. The curing light of claim 48 wherein said reflective surface comprises a thin coating of metal.

50. The curing light of claim 48 wherein said reflective surface is concave for directing and/or focusing the light form the light source to a desired location, such as the mouth of a patient.

51. The curing light claim 46 comprises a housing comprising a polymer, and a polymeric molded reflector having a reflective coating on its inside surface.

52. The curing light of claim 48 wherein said reflective surface comprises a metal coating, formed by vacuum deposition.

53. The curing light of claim 46 wherein said reflector and at least the portion of the housing close to the reflector comprise the same material.

54. The curing light of claim 48 wherein said reflective coating is of a thickness so as not to affect the expansion properties of the material comprising the reflector.

55. The curing light of claim 46 wherein said reflector is attached to the housing wit an attachment means selected from the group consisting of an adhesive bond, a mating of grooves or threads present in either one or both mating surfaces of the housing and the reflector.

56. The curing light of claim 48 wherein said reflective coating is of sufficient thickness and/or substantial uniformity to form an efficient reflective surface.

57. The curing light of claim 48 wherein said reflective coating is formed of a material selected from the group consisting of aluminum, anodized aluminum, indium/tin oxide, silver, gold and mixtures thereof.

58. The curing light of claim 46 wherein said material is selected from the group consisting of an amorphous thermoplastic polyetherimide; a composite of polycarbonate and polybutyleneterephthalate; a copolymer of polycarbonate and isophthalate terephthalate resorcinol resin; high impact polystyrene; polyesters; polyethylene; polyvinyl chloride; polypropylene and mixtures and composites thereof.

59. The curing light of claim 58 wherein said polymeric composites is selected from the group consisting of engineering prepregs, conductive composites, and mixtures thereof.
